(19) United States
(12) Patent Application Publication
(10) Pub. No.: US 2013/0218927 A1
(43) Pub. Date: Aug. 22, 2013

(54) METHOD FOR SCALING OPHTHALMIC IMAGING MEASUREMENTS TO REFLECT FUNCTIONAL DISABILITY RISK

(71) Applicant: Carl Zeiss Meditec, Inc., (US)

(72) Inventors: Vincent Michael PATELLA, Albany, CA (US); Mary K. DURBIN, San Francisco, CA (US); Matthew J. EVERETT, Livermore, CA (US)

(73) Assignee: CARL ZEISS MEDITEC, INC., Dublin, CA (US)

(21) Appl. No.: 13/766,602

(22) Filed: Feb. 13, 2013

Related U.S. Application Data
(60) Provisional application No. 61/600,471, filed on Feb. 17, 2012.

(51) Int. Cl. G06F 17/30

(52) U.S. Cl. CPC G06F 17/30292
USPC 707/796

(57) ABSTRACT

Methods for relating ophthalmic structural measurements to ophthalmic function are presented. The central idea is that each value for a given structural measurement can be empirically associated with a certain likelihood of disability or reduced function by measuring relevant patient populations in which some subjects have those disabilities This method is intended as an aid to doctors who manage glaucoma, or for the study of glaucoma or glaucoma therapy in clinical trials. The method could also be used in other progressive diseases where more than one method is used to diagnose and manage disease, and it is desirable to use a structural method to predict the risk of further functional loss.

### PRIORITY

This application claims priority to U.S. Provisional Application Ser. No. 61/600,471 filed on Feb. 17, 2012 hereby incorporated by reference in its entirety.

### TECHNICAL FIELD

The present invention relates to ophthalmic structural measurements, and in particular to relating structural measurements to ophthalmic function and disability.

### BACKGROUND

Glaucoma is a complex group of neurodegenerative diseases that arises from progressive damage to the optic nerve (ON) and retinal ganglion cells (RGCs) and their axons, the retinal nerve fiber layer (RNFL). Functional measurements of visual sensitivities made with the Humphrey® Field Analyzer and Matrix™ perimeter, structural measurements of the RNFL with optical coherence tomography (OCT) and the GDx™ scanning laser polarimeter, and ONH topographic measurements with the Heidelberg Retina Tomograph (HRT) and OCT are all surrogate measures of the underlying RGC populations. While there is significant correlation between these tests, it is not uncommon for a glaucoma patient to be identified in one test but not in another, and similarly, for a normal subject to be flagged as positive in one test but not in another. The apparent disagreement between tests may be due to test-retest variability, dynamic range difference, confounding factors affecting different tests differently, and quality of the tests.

Glaucoma experts and the United States Food and Drug Administration (US FDA) have struggled to define a clear way of relating visual function to structural measurements of critical ophthalmic tissues. The FDA and others have insisted that all structural endpoints be clearly related to levels of visual function known to affect quality of life. The reason for this protracted struggle has been the correct observation that structure and function cannot be definitively related in individual patients, and the assumption that useful endpoints cannot be defined unless such a clear relationship exists for each and every patient. Thus, the goal of this invention is to define a method for obtaining structural endpoints that are acceptable to the FDA and other organizers of clinical trials, and that also may be used to define guidelines for ordinary clinical care.

### SUMMARY

The object of the present invention is to define a method relating ophthalmic structural measurements to ophthalmic function. In particular, the invention includes the following four concepts:
1. The relationship between structure and function is established on a statistical basis, in which risk of disability in a particular patient population or cohort is substituted for exact knowledge that a particular patient must be disabled at a particular structural value.
2. The effective dynamic range of each measurement can be defined relative to clinical criteria, e.g., with one end of the range being the mean or median value found in normal subjects and the other end of the range being the value where a specified percentage prevalence of disability is reached in a particular patient population.
3. Various measurements from different instruments can be compared to each other by defining their dynamic ranges according to the same criteria, as suggested in item 2 immediately above.
4. Using the definition of dynamic range suggested above, forecasts may be made of future disability risk as a means of evaluating the effectiveness of current therapy perhaps in consideration of patient life expectancy, or versus alternatives.

The central idea is that each value for a given, e.g., structural measurement can be empirically associated with a certain likelihood of disability or reduced function by measuring relevant patient populations in which some subjects have those disabilities. Regression analyses can also be applied to clinical measurements taken over time, in order to estimate each patient's likelihood of reaching some specified risk level. We are then estimating current risk and also predicting future risk.

### BRIEF DESCRIPTION OF THE FIGURES

FIG. 1 is a flowchart illustrating the basic steps of the present invention.

FIG. 2 is a plot showing the cumulative prevalence of subjects with a certain RNFL thickness value in a population of subjects with either severe glaucoma (solid line, diamonds), or blind from glaucoma (dashed lines, squares).

### DETAILED DESCRIPTION

Ophthalmic therapies for diseases such as glaucoma are evaluated in clinical trials and in clinical care on the basis of how well they protect visual function, especially visual acuity and peripheral vision. Trials evaluating glaucoma medications have relied upon quantitative measurements of visual sensitivity in the peripheral visual field (Standard Automated Perimetry, or SAP) and photographic observations of optic nerve changes in defining trial endpoints.

For clinical practice, structural measurements have historically been used to help doctors determine the presence or absence of a particular disease based on comparison to the range of such measurements found in normal subjects. For the case of glaucoma, structural measurements of the RNFL with OCT and scanning laser polarimetry (SLP), and optic nerve head (ONH) topographic measurements with OCT or a confocal scanning laser ophthalmoscope such as the Heidelberg Retina Tomograph (HRT) (Heidelberg Engineering, Heidelberg, Germany) are all surrogate measures of the underlying RGC populations. Structural measurements from these instruments and comparison to normals may be helpful at identifying subjects who have or do not have glaucoma, especially in the early stages of disease, but do not provide much guidance on how the pathology is likely to affect visual function or quality of life as the disease progresses. Here, we use structural measurements to predict the probability of reduced function or disability. Similar ideas have been applied to visual field measurements but not to relating structural measurements to risk of significant functional deficit.

Both the FDA and pharmaceutical companies have expressed strong interest in establishing clinical guidelines relating visual function and risk of visual disability to structural measurements made by automated ophthalmic imaging devices such as spectral-domain OCT (SD-OCT). Similarly, clinicians seek guidelines allowing them to rely more on ophthalmic imaging and less on automated perimetry in managing glaucoma. In both cases, interest in ophthalmic imaging is related to its increased objectivity, ease of use, and quickness, compared to automated perimetry.

Thus far, researchers have searched for methods relating structural measurements—such as those obtained by OCT—to specific levels of visual function, in order to establish the required relationships. This approach has failed for two reasons. First, the correlation between structural measurements like OCT and SAP is only moderate, with R² values commonly running below 0.50. Thus structural measurements to date have not been definitively predictive of function and vice versa. Second, ophthalmic imaging measurements such as retinal nerve fiber layer thickness (RNFL) have floor effects. They often do not go to zero in blindness. Different instruments, different measurements, and different analysis techniques have different floors and it has thus far been difficult to compare dynamic ranges across instruments or even from one type of measurement to another in the same instrument.

This invention provides a rationale for relating ophthalmic imaging measurements to present or future visual disability risk. It requires ophthalmic structural and functional measurements to be related at only one point in the dynamic range of the ophthalmic imaging device and defines the other end of the dynamic range in terms of findings in normal subjects.

Several ideas form the basis of the invention described herein. First, it is sufficient and perhaps preferable to relate structure and function on a statistical basis by determining the empirical likelihood of some condition, e.g. legal blindness or disability within defined groups of glaucoma patients as a function of their measurements with the ophthalmic imager in question—completely abandoning any requirement that a relationship between structure & function be developed that works perfectly for each and every patient at each and every measurement point.

Second, for any clinical patient population, the cumulative risk of disability can be determined for any chosen range of a structural metric, e.g. mean Cirrus OCT retinal nerve fiber layer (RNFL) thickness (Carl Zeiss Meditec, Inc. Dublin, Calif.) or Heidelberg Retinal Tomograph (HRT) optic nerve neuroretinal rim area. For example, we can ask how many patients having mean RNFL thicknesses between 65 and 70 microns, as measured on a specific device using defined analysis algorithms qualify for visual disability according to established Social Security standards. If we divide the whole RNFL dynamic range up into 2 or 5 micron intervals and tally the number of disabled patients in each interval, we will find some RNFL thickness interval that is associated with a level of disability risk that is of interest to study designers or regulators or doctors. We can also establish the degree to which the likelihood of disability increases as the structural measurement of interest changes.

The dynamic range of any metric can then be defined, for instance, using two points, one being the median normal value (the 50^{th} percentile value in a population of normal subjects) and the other being the value associated with some agreed level of disability risk in some defined population of patients, facilitating comparison among and between various metrics from various instruments. The range between these values can be divided up into convenient intervals. Of course, some patients will have measurements outside of the range on this scale. However, the maximum and minimum values will have specific meanings, allowing comparison of measurements on any ophthalmic imaging device having the required dynamic range.

More generally, this scaling approach might be used to relate any bodily function, e.g. hearing, to any appropriate structural measurement, or structure and function to any other relevant category of clinical observations.

Finally, this process might be tailored to particular clinical situations by way of defining selected patient populations according to the needs of the clinical trial or task at hand. Clinical referral guidelines might be developed based upon current disability risk. The accuracy of such referrals might be further refined by establishing different guidelines based upon disease stage, the presence of concomitant disease or other risk factors, Regression analyses might be performed to estimate the likelihood that a patient might reach a certain disability risk level at some future date, if the present therapeutic regimen were to be continued.

This method is intended as an aid to doctors who manage glaucoma, or for the study of glaucoma or glaucoma therapy in clinical trials. The method could also be used in other progressive diseases where more than one method is used to diagnose and manage disease, and it is desirable to use a structural method to predict the risk of further functional loss. More generally, the method could be applied to relate any number of diagnostic methods, for example to relate visual function or hearing to physiological measures to structural measures.

In the preferred embodiment, the goal is to use structural measurements made from OCT to identify patients already at significant risk of functional disability or reduced visual function, and also to identify those whose measurements are changing at such a rate that they are at significant risk of becoming visually disabled in the foreseeable future or during their expected lifetime. A variety of OCT structural measurements including but not limited to mean RNFL thickness, optic nerve neuroretinal rim area, optic nerve cup to disk ratio, ganglion cell layer thickness, or some average of macular inner retinal layer thickness are well known by those skilled in the art (see for example Mwanza et al. “Ability of Cirrus HD-OCT Optic Nerve Head Parameters to Discriminate Normal from Glaucomatous Eyes,” Ophthalmology 118(2), 241-248 (2011), Leung et al. “Retinal nerve fiber layer imaging with Spectral-Domain Optical Coherence Tomography: Interpreting the RNFL maps in healthy myopic eyes,” Invest Ophthalmol Vis Sci 53(11); 7194-7200 (2012), Mwanza et al. “Profile and Predictors of Normal Ganglion Cell-Inner Plexiform Layer Thickness Measured with Frequency-domain Optical Coherence Tomography,” Invest Ophthalmol Vis Sci 52(11); 7872-7879 (2011), Mwanza et al. “Macular ganglion cell-inner plexiform layer: automated detection and thickness reproducibility with spectral domain-optical coherence tomography in glaucoma” Invest Ophthalmol Vis Sci 52(11); 8323-8329 (2011) hereby incorporated by reference).

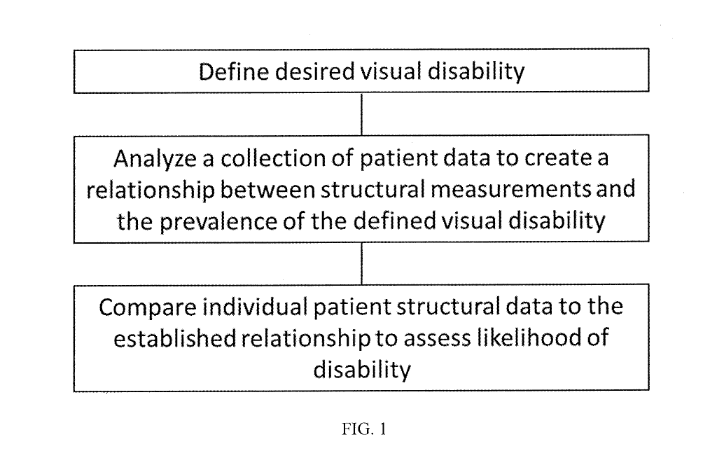

A flowchart illustrating the basic steps of the present invention is illustrated in FIG. 1. The central idea is that each value for a given structural measurement can be empirically associated with a certain likelihood of disability or reduced function by measuring relevant patient populations in which some subjects have those disabilities. Regression analyses can also be applied to clinical measurements taken over time, in order to estimate each patient's likelihood of reaching some specified risk level. From this it is possible to estimate current risk and also predict future risk.

The method can be broken down into three steps:

Step 1: Define the disability, or reduced function to be avoided. This might be reduced visual acuity, perimetric blindness, or significant or disabling loss of peripheral vision. An example of disabling loss of peripheral vision might be considered to be severe glaucoma or visual field mean deviation as reported by the HFA worse than −15 dB. It might be some accepted disability standard such as the Social Security criterion for legal blindness or deafness. Or it might be some quality of life level measured using a standard instrument such as the NEI VFQ or physical disability as defined by government regulations. Or it could be simple observation of whether or not patients have chosen to cease driving an automobile, or whether or not they are reporting difficulty with everyday tasks such as facial recognition or walking.

Step 2: Establish a relationship or scale between the prevalence of the disability selected in Step 1 and one or more structural measurements from a selected group of collected patient data. Identify the prevalence of the disability chosen in #1 in a large population of suitably chosen patients versus the imaging metric of interest, e.g. mean OCT RNFL thickness. If we divide the whole RNFL dynamic range up into, for instance 2 micron or 5 micron intervals and tally the number of disabled patients in each interval, we will find some RNFL thickness interval that is associated with a level of disability risk that is of interest. In one embodiment of the present invention, this level of interest could be the trigger level of risk of that disability that will serve as an end point. For any specific clinical trial, we could define a disability risk level that is sufficiently high as to qualify as a study end point. One skilled in the art can envision many potential desirable endpoints. Perhaps study designers wish to define a trial endpoint as that RNFL thickness that is associated with 5% prevalence of the chosen disability. Alternately they might choose as an endpoint any observed rate of progression that is predictive of arriving at a structural measurement having a 50% disability likelihood e.g. within 5 years or during the patient's median life expectancy.

In a preferred embodiment, a scale is created wherein one end point on the scale corresponds to the value of the specific structural measurement associated with a first predetermined percentage of eyes in the database having the disability and the other end point of the scale corresponds to the value of the specific structural measurement associated with a second predetermined percentage of eyes in the database having the disability. The first endpoint could be defined as the measurement level associated with 50% disability prevalence and that point is defined as one end of the measurement scale (the 0% point), with median normal being the other end (the 100% point). The clinical endpoint might then be chosen to be some other point on the this defined scale. This relationship or mapping of structural measurements and disability prevalence is stored either within a particular structural measurement instrument or on a separate data analysis platform for use in future analysis of individual patient data.

Step 3: Compare the data of a particular patient with the established relationship to assess likelihood of future disability. This can be accomplished by determining where the structural measurement value of the patient falls on the scale established in step 2. The structural measurement or measurements of a particular patient and their clinical information are used to determine the likelihood that they will experience the disability using the established relationship.

Note that Step 3 might be executed for more than one type of instrument and/or more than one type of measurement. In this case, the various instruments or measurement types could then be compared on a common scale. Additional information could be considered, for example, in establishing the relationship between the structural data and the risk of disability. Visual field measurements could be incorporated into the analysis. It may be desirable to incorporate additional clinical information into the assessment of risk. Patient population (clinical setting, population for particular practice, ophthalmologist vs. optometrist), patient demographics (race, ethnicity, sex, age), clinical measurements (intraocular pressure, central corneal thickness), physical parameters (axial length of the eye), the clinician's diagnosis of the state of the patient, and pre-test probability of the condition of interest could all be used as part of the assessment. For instance, an eye with a high IOP and a thin central cornea belongs to a population with a much higher prevalence of glaucomatous damage, and thus might be flagged as being in more danger of progression to disability in the presence of a thicker RNFL than an eye with normal pressure and corneal thickness measurements. As another example, a patient with a family history of glaucoma is also in a higher risk group, and therefore might have a higher probability of progression to disability in the presence of only moderate RNFL loss. These adjustments could be made on the basis of applying a likelihood ratio to a higher initial pre-test probability. In addition, the state of the 2^{nd} eye could be included in the assessment. This could be accomplished through structural or visual field measurements. In both cases, dissimilarities between the eyes might tend to make, e.g. the healthier eye more suspect for progression to disability. Alternately, the definition of disability might require input from both eyes, since risk of disability when there is only one functional eye is much higher. One skilled in the art can demonstrate many other ways to incorporate clinical, demographic, and family history information into a full analysis of the likelihood of progression to disability.

In a preferred embodiment of the present invention, the above steps might be used to define a standardized measurement scale for mean RNFL thickness on the Cirrus OCT. One end point on the measurement scale might be defined as that value having a 50% prevalence of disability, maybe 48 microns. The other end point on the scale might be defined to be the median normal value in the Cirrus original normative database, which is 93 microns. The total measurement range from normal to 50% disability risk would then be 45 microns. If our 95% confidence limits on test—retest variability were about 4.5 microns, we would be able to measure about 10 steps from nominally normal to nominally disabled. A patient might then be defined as having progressed (and therefore meet the endpoint criterion) if their structural measurement confirmably changed, e.g. by 2 or more measurement steps between visits. Or, patients might be seen to be progressing at a dangerous rate, if that rate, when extrapolated X years into the future predicted a significant risk of approaching 48 microns.

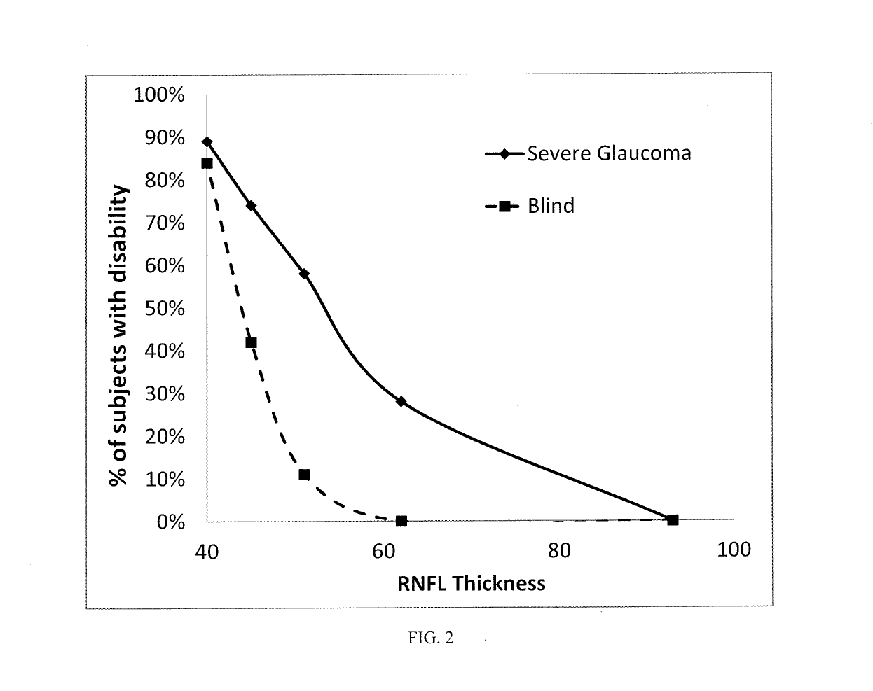

FIG. 2 illustrates OCT RNFL thickness values and disability prevalence for two different disability states, patients with severe glaucoma (diamonds) and patients who are legally blind (squares). The chart is created by adapting data from Sihota R et al. “Diagnostic capability of optical coherence tomography in evaluating the degree of glaucomatous retinal nerve fiber damage” Invest Ophthalmol Vis Sci. 2006 May; 47(5):2006-10. The prevalence of thinned RNFL values is much higher in a disabled population, such as those who are blind from glaucoma or those with severe glaucoma. For an RNFL thickness of 60 microns, there is very little likelihood of being blind, but 30% of subjects with severe glaucoma have an RNFL thickness at 60 microns or lower.

The data collected in this study or a similar study as described in Step 1 above would allow determination of the percentage of a glaucomatous population with severe glaucoma who have 60 microns or less of RNFL, and this percentage could be reported if this was the endpoint of interest. A subject who had 60 microns now, but was progressing at a rate of 2 microns loss per year, would be expected to get to an RNFL thickness associated with 74% chance of having severe glaucoma (which may not concern the patient or the doctor), but a level associated with a 42% chance of being blind from glaucoma (which may be of higher concern).

Although various applications and embodiments that incorporate the teachings of the present invention have been shown and described in detail herein, those skilled in the art can readily devise other varied embodiments that still incorporate these teachings.

The following references are hereby incorporated by reference:
Leung, Liu, Weinreb, et al, “Evaluation of Retinal Nerve Fiber Layer Progression in Glaucoma: A comparison between Spectral-Domain and Time-Domain Optical Coherence Tomography,” Ophthalmology 118(8); 1558-1562 (2011).
Hood, DC et al. “A framework for comparing structural and functional measures of glaucomatous damage,” Prog Retin Eye Res 26(6); 688-710 (2010).
Hood DC et al. “Structure versus Function in Glaucoma: An application of a Linear Model,” Invest Ophthalmol Vis Sci 48(8); 3662-3668 (2007).
Sihota R. et al. “Diagnostic capability of optical coherence tomography in evaluating the degree of glaucomatous retinal nerve fiber damage,” Invest Ophthalmol Vis Sci. 47(5); 2006-10 (2006).

Mwanza et al. “Ability of Cirrus HD-OCT Optic Nerve Head Parameters to Discriminate Normal from Glaucomatous Eyes,” Ophthalmology 118(2), 241-248 (2011).

Leung et al. “Retinal nerve fiber layer imaging with Spectral-Domain Optical Coherence Tomography: Interpreting the RNFL maps in healthy myopic eyes,” Invest Ophthalmol Vis Sci 53(11); 7194-7200 (2012).

Mwanza et al. “Profile and Predictors of Normal Ganglion Cell-Inner Plexiform Layer Thickness Measured with Frequency-domain Optical Coherence Tomography,” Invest Ophthalmol Vis Sci 52(11); 7872-7879 (2011).

Mwanza et al. “Macular ganglion cell-inner plexiform layer: automated detection and thickness reproducibility with spectral domain-optical coherence tomography in glaucoma” Invest Ophthalmol Vis Sci 52(11); 8323-8329 (2011).

What is claimed is:

1. A method to identify risk of present and future visual disability based on structural measurements of an eye of a patient, said method comprising:
creating a database of information including structural measurements for a plurality of eyes and the disability status of each eye for a defined visual disability;
establishing a relationship between the structural measurements in the database and the prevalence of the disability among the plurality of eyes;
comparing the value of a specific structural measurement of the eye of the patient using the established relationship to determine a probability of visual disability for the individual patient; and
storing or displaying the probability of visual disability.

2. A method as recited in claim 1, wherein the establishing a relationship step is accomplished by creating a scale wherein one end point on the scale corresponds to the value of the specific structural measurement associated with a first predetermined percentage of eyes in the database having the disability and the other end point of the scale corresponds to the value of the specific structural measurement associated with a second predetermined percentage of eyes in the database having the disability.

3. A method as recited in claim 2, wherein one of the percentages is zero and corresponds to an eye that is not disabled.

4. A method as recited in claim 2, wherein one of the percentages is 50% disability prevalence.

5. A method as recited in claim 1, wherein the structural measurements are selected from the group consisting of: RNFL thicknesses, optic nerve neuroretinal rim areas, optic nerve cup to disk ratios, and ganglion cell layer thicknesses.

6. A method as recited in claim 5, wherein the structural measurements are made using optical coherence tomography.

7. A method as recited in claim 1, wherein the visual disability is selected from the group consisting of: reduced quality of life, reduced visual acuity, perimetric blindness, physical disability, and significant loss of peripheral vision.

8. A method as recited in claim 5, further comprising using visual field measurements in addition to OCT measurements.

9. A method as recited in claim 1, wherein the probability of a future risk of visual disability is determined.

10. A method as recited in claim 1, further comprising using other clinical information in addition to the structural measurement for determining the probability of visual disability.

11. A method as recited in claim 1, further comprising using information on the state of the second eye of the patient in addition to structural measurement of the first eye to determine the probability of visual disability.

12. A method as recited in claim 1, further comprising analyzing a second structural measurement of a patient taken at a later time or times to determine a risk of future disability based on the rate at which the structural measurement changes over time.

13. A method to identify future likelihood of visual disability based on structural measurements of the eye of a patient, said method comprising:
creating a database of information including structural measurements for a plurality of eyes and the disability status of each eye for a defined visual disability;
establishing a statistical relationship between the structural measurements in the database and the likelihood of developing one or more visual disability endpoints within a fixed time frame;
comparing the value of a specific structural measurement of the eye of the patient using the established relationship to determine a probability of visual disability for an individual patient within the fixed time frame; and
storing or displaying the probability of visual disability.

14. A method of assigning a probability of disability of a patient's eye based upon optical coherence tomography (OCT) measurements comprising:
creating a database of information including OCT measurements of a specific structural feature of a plurality of eyes and the disability status of the eyes;
creating a scale wherein one end point of the scale corresponds to the value of the specific structural feature associated with a first predetermined percentage of eyes in the database having the disability and the other end point of the scale corresponds to the value of the specific structural measurement associated with a second predetermined percentage of eyes in the database having the disability; and
comparing the value of the specific structural feature measured in the patient's eye to the scale to determine the probability that the patient's eye currently has or will develop the disability.

15. A method as recited in claim 14, wherein the OCT measurements are selected from the group consisting of: RNFL thicknesses, optic nerve neuroretinal rim areas, optic nerve cup to disk ratios, and ganglion cell layer thicknesses.

16. A method as recited in claim 14, wherein one of the percentages is zero and corresponds to an eye that is not disabled.

17. A method as recited in claim 14, wherein one of the percentages is 50% disability prevalence.

18. A method as recited in claim 14, wherein the disability is selected from the group consisting of: reduced quality of life, reduced visual acuity, perimetric blindness, physical disability, and significant loss of peripheral vision.

19. A method as recited in claim 14, further comprising using information on the state of the second eye of the patient in addition to structural measurement of the first eye to determine the probability of disability.

20. A method as recited in claim 14, further comprising analyzing a second structural measurement of a patient taken at a later time or times to determine a risk of future disability based on the rate at which the structural measurement changes over time.
